(19) United States
(12) Patent Application Publication
(10) Pub. No.: US 2019/0225054 A1
(43) Pub. Date: Jul. 25, 2019

(54) HEATING DEVICE AND METHOD FOR PRODUCING A HEATING ROD

(71) Applicant: BorgWarner Ludwigsburg GmbH, Ludwigsburg (DE)

(72) Inventors: Kevin Dukes, Trallee Co. Kerry (IE); Ivan Morris, Glencar Co. Kerry (IE)

(21) Appl. No.: 16/000,397

(22) Filed: Jun. 5, 2018

(30) Foreign Application Priority Data
Jan. 23, 2018 (DE) 10 2018 101 453.8

(51) Int. Cl. B60H 1/22

(52) U.S. Cl. CPC B60H 1/2225; H05B 2203/017

(57) ABSTRACT

Disclosed is a heating device comprising a heating resistor, a tube, in which the heating resistor is arranged, and heat sink fins connected to the tube. The heat sink fins are skived fins integral to the tube. Also disclosed is a method for producing a heating rod comprising the steps of arranging a heating resistor in a tube, and providing the tube with heat sink fins by skiving.

### RELATED APPLICATIONS

This application claims priority to DE 10 2018 101 453.8, filed Jan. 23, 2018, the entire disclosure of which is hereby incorporated herein by reference.

### BACKGROUND

This disclosure refers to a heating device and to a method for producing a heating rod. Heating devices of the type disclosed herein are known in a general sense from DE 203 12 313 U1.

Such heating devices are used for heating air in a vehicle. Heat is produced by means of one or more electrical resistors inside a tube. The heat is then transferred to an air or gas stream by means of heat sink fins connected to the tube. In the device known from DE 203 12 313 U1 the heat sink fins are cut from sheet metal and then pushed onto the tube.

Cutting heat sink fins from sheet metal and pushing them onto the tube involves considerable work. Moreover, the thermal contact between the heat sink fins and the tube can be compromised by oxide layers or dirt. In order to alleviate these disadvantages, heating devices can be made from extruded profiles as disclosed in DE 10 2006 018 784 A1. The extruded profile comprises several tubes and a plate that connects them and has heat sink fins integrally provided by the plate. Holes are then cut into the plate so that air to be heated can flow through the openings and thereby along the heat sink fins. A problem of this design is a relatively high flow resistance for air to be heated.

### SUMMARY

This disclosure shows how a heating device for heating the passenger compartment of a vehicle can be produced economically that has an advantageous low flow resistance for air to be heated and an excellent thermal contact between heat sink fins and tube.

According to this disclosure, the heat sink fins are skived fins. Skived heat sink fins are manufactured by peeling fins from a metal tube, e.g., aluminum, using a sharp and accurately controlled blade tool. The tool shaves a small thickness of the material, lifts it up and bends it vertically to form the fin. This process is called skiving. The production of heat sink fins by skiving is disclosed in detail in US 2001/0030039 A1, the disclosure of which is hereby incorporated herein by reference.

Skived heat sinks are integral to the tube, i.e., the heat sink fins and the tube are a single piece. As a consequence, the assembly of the heating device is simplified and thermal resistance between the tube and the heat sink fins minimized.

Instead of providing the heat sink fins by skiving a tube it is also possible to provide heat sink fins on a flat metal sheet that is bent into in tube after the skiving process. For example, two parallel rows of skived fins may be provided an a metal sheet that is then bent into a flat tube such that the heat sink fins are arranged on opposite sides of the tube.

An advantageous refinement of this disclosure is that the heating resistor is a ceramic heating resistor, e.g., a PTC (positive temperature coefficient) resistor. Such resistors may be made on the basis of barium titanate. As PTC resistors show a marked increase in their electrical resistance at a critical temperature, they are inherently protected from overheating beyond their critical temperature. The tube may contain just one heating resistor or it may contain several heating resistors.

A ceramic resistor can be electrically contacted inside the tube by means of a contact plate. A suitable contact plate can be made from sheet metal and protrude from the tube thereby providing an electrical terminal for connecting the heating device to an electrical power supply. The tube itself can be used for connecting the resistor to ground. It is also possible to provide a second contact plate inside the tube and arranging the heating resistor between the contact plates.

Another advantageous refinement of this disclosure is that the resistor(s) and the contact plate(s) are held by a mounting frame. Thereby, assembly can be facilitated.

In principle, the heat sink fins can be created by skiving bevor the heating resistor is arranged in the tube or after. An advantageous refinement of this disclosure is that the heating resistor is arranged in the tube, the tube is then plastically deformed by compressing it, and thereafter the heat sink fins are produced by skiving, i.e., shaving a layer of material from the surface of the tube, lifting it up and bending it vertically. Compressing the tube improves the thermal connection of the heating resistor(s) to the tube. Heat sink fins complicate the compressing process. Therefor it is more advantageous the compress the tube first and to then provide the heat sink fins on the tube by skiving.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a heating device;

FIG. 2 shows a tube of the heating device; and

FIG. 3 shows a mounting frame including a contact plate and a heating resistor of the heating device.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

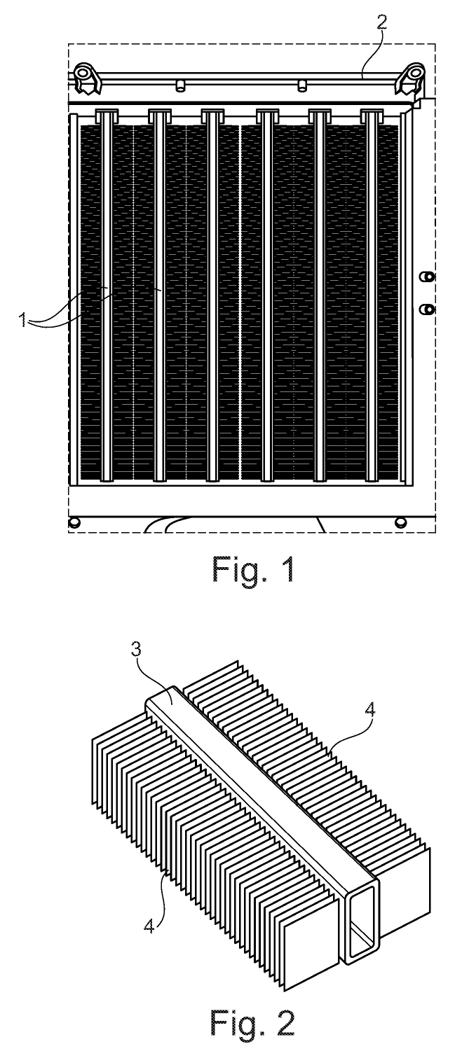

FIG. 1 shows a heating device for heating the passenger compartment of a car. The heating device comprises six heating rods 1 and a holder 2 holding the rods. The holder 2 can be a rectangular frame surrounding the heating rod 1, or it may be a flange plate with openings in which the heating rod 1 are stuck. The heating device may be installed in a duct through which air to be heated is blown.

Each of the heating rods 1 comprises a tube 3 as shown schematically in FIG. 2. The tube 3 is provided with heat sink fins 4. The heat sink fins 4 are skived fins integral to the tube 3. This means that the heat sink fins 4 were made by skiving from a flat tube. In the skiving process fins were peeled from the flat tube using a sharp and accurately controlled blade tool. The blade tool shaves a small thickness of the tube surface, lifts it up and bends it vertically to form the fins 4 one after another. Two opposite sides of the tube 3 are provided with skived heat sink fins 4. The heat sink fins 4 are provided on broad sides of the tube 3. These broad sides are connected by narrow sides which are free from heat sink fins. The tube 3 and the heat sink fins 4 are a single piece, e.g., of aluminum.

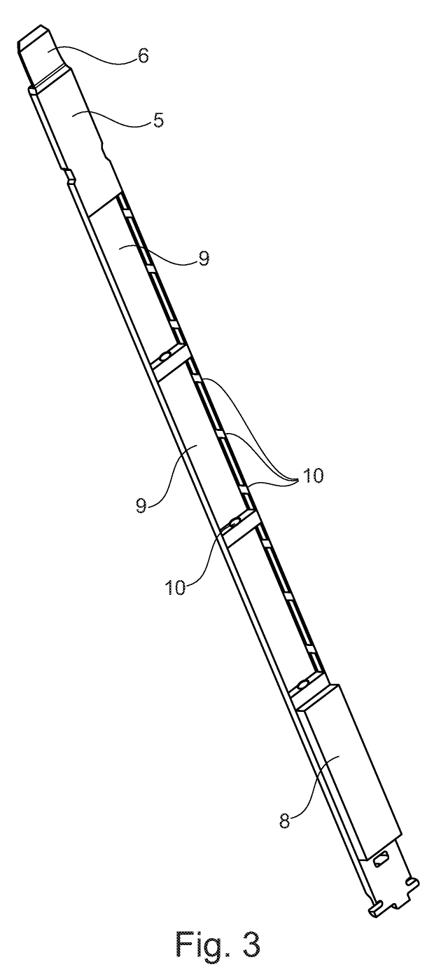

Inside the tube 3 is a mounting frame 5 holding a contact plate 6 and one or more ceramic heating resistors 8, e.g., PTC heating resistors. The mounting frame 5 is shown in FIG. 3 with only one ceramic heating resistor 8, the other three compartments 9 of the mounting frame 5 are empty for simplicity, but could of course also be filled with heating resistors 8. The mounting frame 5 may be provided with noses 10 for holding the ceramic heating resistors 8 in the compartments 9.

The heating resistors 8 are electrically contacted by the contact plate 6 which protrudes from the tube 3 forming a terminal for connecting to an electrical power source. The contact plate 6 is electrically insulated from the tube 3. A second contact plate may be provided inside the tube 3, or the tube 2 itself me be used to provide a ground connection for the heating resistors 8.

The heating device can be produced by arranging the heating resistors 8 together with the mounting frame 5 and the contact plate 6 inside a tube 3. The tube 3 can then be plastically deformed by compressing it. Thereby the thermal contact between the heating resistors 8 and the tube 3 can be improved. The heating resistors 8 are usually provided as plates or strips, i.e., their thickness is smaller than their length and width, and the tube 3 a flat tube. A flat tube usually has two larger or broader sides that are connected by smaller or narrower sides. When the tube 3 is compressed, pressure is applied to the larger sides of the heating resistors 8 and also on the larger sides of the flat tube. After compressing, the tube is provided with heat sink fins 4 by skiving. It is also possible to skive firstly and then press.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 heating rod
2 frame
3 tube
4 heat sink fin
5 mounting frame
6 contact plate
8 heating resistor
9 compartment
10 nose

What is claimed is:

1. A heating device, comprising:
a heating resistor;
a tube in which the heating resistor is arranged; and
heat sink fins connected to the tube;
wherein the heat sink fins are skived fins integral to the tube.

2. The heating device according to claim 1, wherein the heating resistor is a ceramic heating resistor that is electrically contacted by a contact plate protruding from the tube.

3. The heating device according to claim 2, comprising a mounting frame holding the heating resistor and the contact plate.

4. The heating device according to claim 1, wherein the tube is a flat tube.

5. The heating device according to claim 1, wherein skived heat sink fins are arranged on opposite sides of the tube.

6. The heating device according to claim 1, wherein the tube comprises a plurality of tubes and the heating device further comprises a holder holding the plurality of tubes.

7. A method for producing a heating rod, comprising the steps of:
arranging a heating resistor in a tube, and
providing the tube with heat sink fins by skiving.

8. The method according to claim 7, wherein the tube is plastically deformed by compressing it after the heating resistor has been arranged inside the tube, but before the skiving.

9. The method according to claim 7, wherein the tube is a flat tube and the heat sink fins are provided by skiving on opposite broad sides, the broad sides having a larger width than narrow sides connecting the broad sides.

10. The method according to claim 8, wherein the tube is compressed by pressing on a broad side thereof.

11. The method according to claim 7, wherein the heat sink fins are provided by skiving on a sheet metal that is bent into a tube after the skiving process.
